(19) United States
(12) Patent Application Publication
(10) Pub. No.: US 2026/0323354 A1
(43) Pub. Date: Oct. 15, 2026

(54) MEASUREMENT REPORT ENHANCEMENT FOR FREQUENCY HOPPING IN POSITIONING

(71) Applicant: Telefonaktiebolaget LM Ericsson (PUBL), Stockholm (SE)

(72) Inventors: Zhilan Xiong, SOLNA (SE); Florent Munier, VÄSTRA FRÖLUNDA (SE); Chunhui Zhang, STOCKHOLM (SE); Deep Shrestha, LINKÖPING (SE); Xiaolin Jiang, LINKÖPING (SE)

(21) Appl. No.: 19/483,646

(22) PCT Filed: May 7, 2024
(86) PCT No.: PCT/SE2024/050435

§ 371 Date: Nov. 12, 2025

Related U.S. Application Data
(60) Provisional application No. 63/502,339, filed on May 15, 2023.

(51) Int. Cl. H04W 24/10; H04B 1/713; H04W 24/08; H04W 64/00

(52) U.S. Cl. CPC H04W 24/10; H04B 1/713; H04W 24/08; H04W 64/00

(57) ABSTRACT

Methods, radio nodes, and network nodes for measurement reporting for frequency hopping in positioning. One aspect of the invention provides a method performed by a radio node. The method comprises reporting, to a first network node, one or more measurement values associated with a measured reference signal. The report is based on measurements of the reference signal over one or more frequency hops across a narrowband or a wideband. At least one of the one or more measurement values is associated with an accumulated bandwidth over one or more frequency hops across the narrowband or the wideband. The measurement values are reported together with an associated bandwidth information, the associated bandwidth information indicating whether the report is based on narrowband or wideband measurements.

### TECHNICAL FIELD

The present disclosure relates to wireless communications, and in particular, to methods for measurement reporting for frequency hopping in positioning.

### BACKGROUND

3^{rd} Generation Partnership Project (3GPP) is discussing New Radio (NR) positioning Rel-18 with the potential enhancements for Reduced Capability (RedCap) positioning in which the maximal bandwidth of RedCap User Equipment (UE) is 20 MHz in Frequency Range 1 (FR1) and 100 MHz in Frequency Range 2 (FR2). The potential solutions include partially overlapped Uplink (UL) Sounding Reference Signal (SRS) frequency hopping for the positioning accuracy improvement of uplink-related RedCap positioning and partially overlapped Downlink (DL) Positioning Reference Signal (PRS) frequency hopping for the positioning accuracy improvement of downlink-related RedCap positioning.

One agreement in RAN1 #113 is:

### Agreement

For DL Rx hopping or UL Tx hopping, support the UE or gNodeB (gNB) to report the following:
   A single measurement based on receiving multiple hops of the DL PRS or UL SRS for positioning
   One [or more] measurements where each measurement is associated with one received hop
   FFS: conditions when the above measurements are reported, and whether the above measurements can be reported together

### SUMMARY

There currently exist certain challenge(s). For example, no new measurement definition is introduced in RAN1. As another example, the measurement report for PRS frequency hopping from the UE to Location Management Function (LMF) and the measurement report for SRS frequency hopping from gNB to LMF is not defined in the specification. Additionally, the agreement leaves for future study, indication of how many received hops and/or which received hops used in a measurement report. The agreement also leaves for future study the conditions when the measurements are to be reported and whether the measurements can be reported together.

Certain aspects of the disclosure and their embodiments may provide solutions to these or other challenges. For example, methods and systems are provided to support measurement reports of DL PRS frequency hopping from UE to LMF and measurement reports of UL SRS frequency hopping from gNB to LMF.

A first aspect of the invention provides a method for measurement reporting for frequency hopping in positioning, performed by a radio node. The method comprises reporting, to a first network node, one or more measurement values associated with a measured reference signal. The report is based on measurements of the reference signal over one or more frequency hops across a narrowband or a wideband. At least one of the one or more measurement values is associated with an accumulated bandwidth over one or more frequency hops across the narrowband or the wideband. The measurement values are reported together with an associated bandwidth information, the associated bandwidth information indicating whether the report is based on narrowband or wideband measurements.

A second aspect of the invention provides a method for receiving measurement reporting for frequency hopping in positioning, performed by a network node. The method comprises receiving, from a radio node, a measurement report comprising one or more measurement values associated with a reference signal, the reference signal being transmitted over a plurality of frequency hops. At least one of the one or more measurement values is associated with an accumulated bandwidth over one or more frequency hops across a narrowband or a wideband. The measurement values are reported together with an associated bandwidth information, the associated bandwidth information indicating whether the report is based on narrowband or wideband measurements.

A third aspect of the invention provides a radio node for measurement reporting for frequency hopping in positioning. The radio node is configured to, and/or comprising processing circuitry configured to report, to a first network node, one or more measurement values associated with a measured reference signal. The report is based on measurements of the reference signal over one or more frequency hops across a narrowband or a wideband. At least one of the one or more measurement values is associated with an accumulated bandwidth over one or more frequency hops across the narrowband or the wideband. The measurement values are reported together with an associated bandwidth information, the associated bandwidth information indicating whether the report is based on narrowband or wideband measurements.

A fourth aspect of the invention provides a network node for receiving measurement reporting for frequency hopping in positioning. The network node is configured to, and/or comprising processing circuitry configured to, receive, from a radio node, a measurement report comprising one or more measurement values associated with a reference signal, the reference signal being transmitted over a plurality of frequency hops. At least one of the one or more measurement values is associated with an accumulated bandwidth over one or more frequency hops across a narrowband or a wideband. The measurement values are reported together with an associated bandwidth information, the associated bandwidth information indicating whether the report is based on narrowband or wideband measurements.

According to certain embodiments relating to measurement reporting for DL PRS frequency hopping, for example, one measurement result is associated with the accumulated bandwidth information if the accumulated bandwidth is not aligned with the full bandwidth of configured PRS transmission, and one accumulated bandwidth has up to one measurement result. It may be up to UE implementation whether to report narrow-bandwidth-based measurement result to LMF.

In a particular embodiment, for example, LMF may indicate UE to report narrow-bandwidth-based measurement result for DL PRS frequency hopping to LMF, and UE may report the measurement result accordingly.

According to various particular embodiments, the UE may report the measurement results to the gNB based on partial hops, for example, based on phase offset measurement information of each hop.

According to various particular embodiments, the UE may report its capability regarding PRS frequency hopping measurement reporting about whether the measurement reporting can be based on preferred bandwidth, whether the measurement reporting can be based on narrowband PRS, whether the measurement report can be based on wideband PRS, and/or whether the measurement report can be based on preferred hops.

According to certain other embodiments relating to the measurement reporting for UL SRS frequency hopping, for example, one measurement result is associated with the accumulated bandwidth information if the accumulated bandwidth is not aligned with the full bandwidth of configured SRS transmission, and one accumulated bandwidth has up to one measurement result. It may be up to gNB implementation whether to report narrow-bandwidth-based measurement result to LMF.

In a particular embodiment, for example, LMF may indicate gNB to report narrow-bandwidth-based measurement result for UL SRS frequency hopping to LMF, and gNB may report the measurement result accordingly.

According to various particular embodiments, the gNB may report the measurement results to the LMF based on partial hops such as, for example, based on phase offset measurement information of each hop.

Certain embodiments may provide one or more of the following technical advantage(s). For example, certain embodiments may provide a technical advantage of supporting measurement reports of DL PRS frequency hopping from UE to LMF. As another example, certain embodiments may provide a technical advantage of supporting measurement reports of UL SRS frequency hopping from gNB to LMF. As still another example, certain embodiments may provide a technical advantage of reducing signal overhead.

Other advantages may be readily apparent to one having skill in the art. Certain embodiments may have none, some, or all of the recited advantages.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 shows an example of a communication system QQ100 in accordance with some embodiments.

FIG. 2 shows a UE QQ200 in accordance with some embodiments.

FIG. 3 shows a network node QQ300 in accordance with some embodiments.

FIG. 4 is a block diagram of a host QQ400, which may be an embodiment, in accordance with various aspects described herein, of the host QQ116 of FIG. 1.

FIG. 5 is a block diagram illustrating a virtualization environment QQ500 in which functions implemented by some embodiments may be virtualized.

FIG. 6 shows a communication diagram of a host QQ602 communicating via a network node QQ604 with a UE QQ606 over a partially wireless connection in accordance with some embodiments.

FIG. 7 illustrates an example method by a radio node for measurement reporting for frequency hopping in positioning, according to certain embodiments.

FIG. 8 illustrates an example method by a first network node for measurement reporting for frequency hopping in positioning, according to certain embodiments.

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ can be a network node or a UE. Examples of network nodes are NodeB, base station (BS), multi-standard radio (MSR) radio node such as MSR BS, eNodeB (eNB), gNodeB (gNB), Master eNB (MeNB), Secondary eNB (SeNB), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS), Self Organizing Network (SON), positioning node (e.g. E-SMLC), etc.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

In some embodiments, generic terminology, “radio network node” or simply “network node (NW node)”, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g. in a gNB), Distributed Unit (e.g. in a gNB), Baseband Unit, Centralized Baseband, C-RAN, access point (AP), etc.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IOT), WiFi, Bluetooth, next generation RAT, NR, 4G, 5G, etc. Any of the equipment denoted by the terms node, network node or radio network node may be capable of supporting a single or multiple RATs.

The term signal or radio signal used herein can be any physical signal or physical channel. Examples of DL physical signals are reference signal (RS) such as Primary Synchronization Signal (PSS), Secondary Synchronization Signal (SSS), CSI-RS, DMRS signals in SS/PBCH block (SSB), discovery reference signal (DRS), CRS, PRS etc. RS may be periodic e.g. RS occasion carrying one or more RSs may occur with certain periodicity e.g. 20 ms, 40 ms etc. The RS may also be aperiodic. Each SSB carries NR-PSS, NR-SSS and NR-PBCH in 4 successive symbols. One or multiple SSBs are transmit in one SSB burst which is repeated with certain periodicity e.g. 5 ms, 10 ms, 20 ms, 40 ms, 80 ms and 160 ms. The UE is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset wrt reference time (e.g. serving cell's SFN) etc. Therefore, SMTC occasion may also occur with certain periodicity e.g. 5 ms, 10 ms, 20 ms, 40 ms, 80 ms and 160 ms. Examples of UL physical signals are reference signal such as SRS, DMRS etc. The term physical channel refers to any channel carrying higher layer information e.g. data, control etc. Examples of physical channels are PBCH, NPBCH, PDCCH, PDSCH, sPUCCH, sPDSCH, sPUCCH, sPUSCH, MPDCCH, NPDCCH, NPDSCH, E-PDCCH, PUSCH, PUCCH, NPUSCH, etc.

The term time resource used herein may correspond to any type of physical resource or radio resource expressed in terms of length of time. Examples of time resources are: symbol, time slot, subframe, radio frame, TTI, interleaving time, slot, sub-slot, mini-slot, system frame number (SFN) cycle, hyper-SFN (H-SFN) cycle etc.

### Measurement Report for Prs Frequency Hopping From UE to LMF

According to certain embodiments, if the UE is able to measure all PRS frequency hops cross full wide bandwidth or if the UE is able to measure partial PRS frequency hops but still cross full wide bandwidth, then the measurement result based on full wide bandwidth has the highest measurement accuracy normally. In this case, the UE reports the measurement result cross full wide bandwidth to the network, and the reported measurement result may be associated with the bandwidth information.

According to certain other embodiments, however, if the UE is unable to measure PRS frequency hops cross full wide bandwidth, but the UE can measure PRS frequency hops cross partial wide bandwidth, then the UE reports the measurement result based on the partial wide bandwidth and the reported measurement result is associated with the bandwidth information.

According to certain other embodiments, if the UE determines that the measurement accuracy based on the narrow bandwidth (i.e., the bandwidth of each hop) is higher than the measurement accuracy based on wide bandwidth (which may be full wide bandwidth or partial wide bandwidth), then the UE reports narrow-bandwidth-based measurement result with associated bandwidth information. The measurement result is still based on one or more hops but does not consider the accumulated bandwidth via frequency hopping. In this case, the UE may also report the measurement result based on full wide bandwidth, and/or may also report the measurement result based on partial wide bandwidth.

According to certain embodiments, the network (e.g., LMF) configures the UE to report narrow-bandwidth-based measurement result, or configures the UE to report both wideband-based measurement result and narrow-bandwidth-based measurement result. The UE reports the measurement results accordingly.

In another embodiment, it is up to UE implementation whether to report the narrowband-based measurement results.

According to a particular embodiment, if the phase offset of one hop (Hop #K) is different from the phase offset of the previous hop or the average phase offset of the hops before this hop by a given threshold (e.g., channel changes), then UE reports the measurement result based on the hops before Hop #K, or reports the measurement result based on the hops including Hop #K and the hops after it, or does not report the measurement result optional with measurement failure code of channel change during frequency hopping.

According to a particular embodiment, the UE can report its capability regarding whether supporting both wideband-based measurement and narrowband-based measurement.

In another particular embodiment, the UE can report its capability regarding whether supporting the reporting of wideband-based measurement result(s) and narrowband-based measurement result(s), whether supporting the reporting of wideband-based measurement result(s), and/or whether supporting the reporting of narrowband-based measurement result(s).

In another particular embodiment, the UE can report its capability regarding whether supporting the reporting of preferred-bandwidth-based measurement result(s). In one example, this measurement reporting means that the UE can report of the results based on its preferred bandwidth(s).

In another embodiment, the UE can report its capability regarding whether supporting the reporting of preferred-hops-based measurement result(s).

In another embodiment, the capability reports in any one or more of the above embodiments are based on LMF request.

### Measurement Report for SRS Frequency Hopping from gNB to LMF

According to certain embodiments, if the gNB is able to measure all SRS frequency hops cross full wide bandwidth or if the gNB is able to measure partial SRS frequency hops but still cross full wide bandwidth, then the measurement result based on full wide bandwidth has the highest measurement accuracy, normally. In this case, the gNB reports the measurement result cross full wide bandwidth to the LMF, and the reported measurement result may be associated with the bandwidth information.

According to certain other embodiments, however, if the gNB is unable to measure SRS frequency hops cross full wide bandwidth, but the gNB can measure SRS frequency hops cross partial wide bandwidth, then the gNB reports the measurement result based on the partial wide bandwidth and the reported measurement result is associated with the bandwidth information.

According to certain other embodiments, if the gNB determines that the measurement accuracy based on the narrow bandwidth (i.e., the bandwidth of each hop) is higher than the measurement accuracy based on wide bandwidth (which may be full wide bandwidth or partial wide bandwidth), then the gNB can report narrow-bandwidth-based measurement result with associated bandwidth information. The measurement result is still based on one or more hops but does not consider the accumulated bandwidth via frequency hopping. In this case, the gNB also reports the measurement result based on full wide bandwidth, and/or may also report the measurement result based on partial wide bandwidth.

According to certain embodiments, the LMF configures the gNB to report narrow-bandwidth-based measurement result, or configures the gNB to report both wideband-based measurement result and narrow-bandwidth-based measurement result. The gNB reports the measurement results accordingly.

In another embodiment, it is up to gNB implementation whether to report the narrowband-based measurement results.

According to certain embodiments, if the phase offset of one hop (Hop #K) is different from the phase offset of the previous hop or the average phase offset of the hops before this hop by a given threshold (e.g., channel changes), then gNB reports the measurement result based on the hops before Hop #K, or reports the measurement result based on the hops including Hop #K and the hops after it, or does not report the measurement result optional with measurement failure code of channel change during frequency hopping.

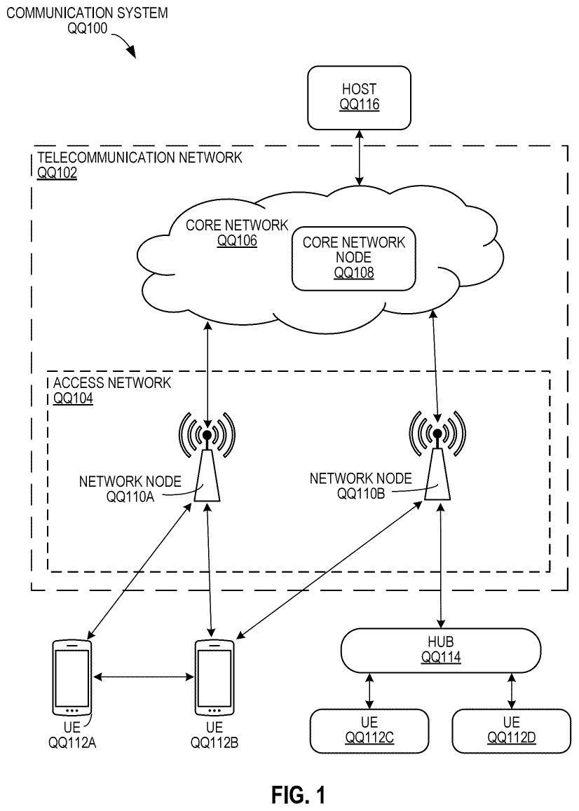

FIG. 1 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server. As a whole, the communication system QQ100 of FIG. 1 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub-that is, a hub whose primary function is to route communications to/from the UEs from/to the network node QQ110b. In other embodiments, the hub QQ114 may be a non-dedicated hub-that is, a device which is capable of operating to route communications between the UEs and network node QQ110b, but which is additionally capable of operating as a communication start and/or end point for certain data channels.

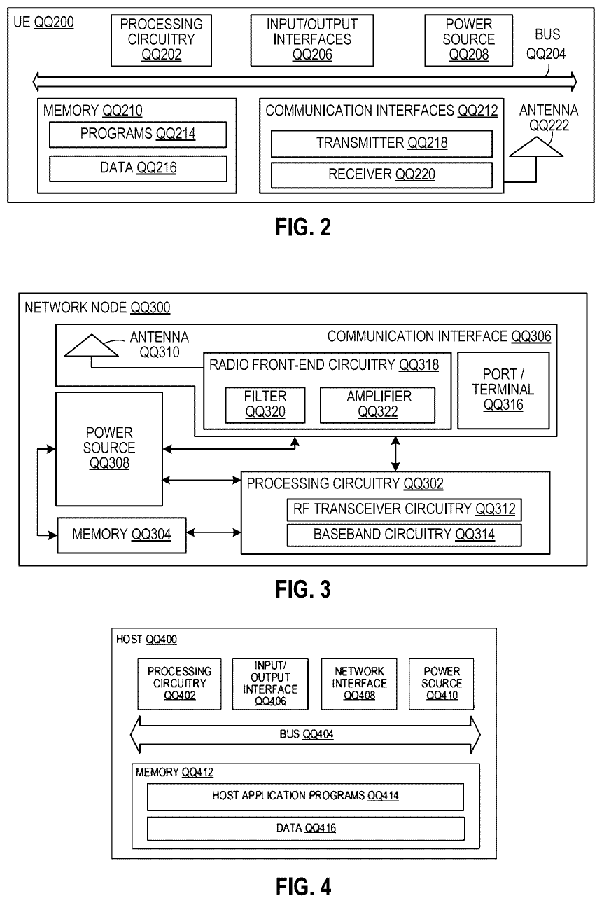

FIG. 2 shows a UE QQ200, which may be an embodiment of the UE 112 of FIG. 1, in accordance with some embodiments.

As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 2. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a Universal Subscriber Identity Module (USIM) and/or IP Multimedia Services Identity Module (ISIM), other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient). As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 2.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

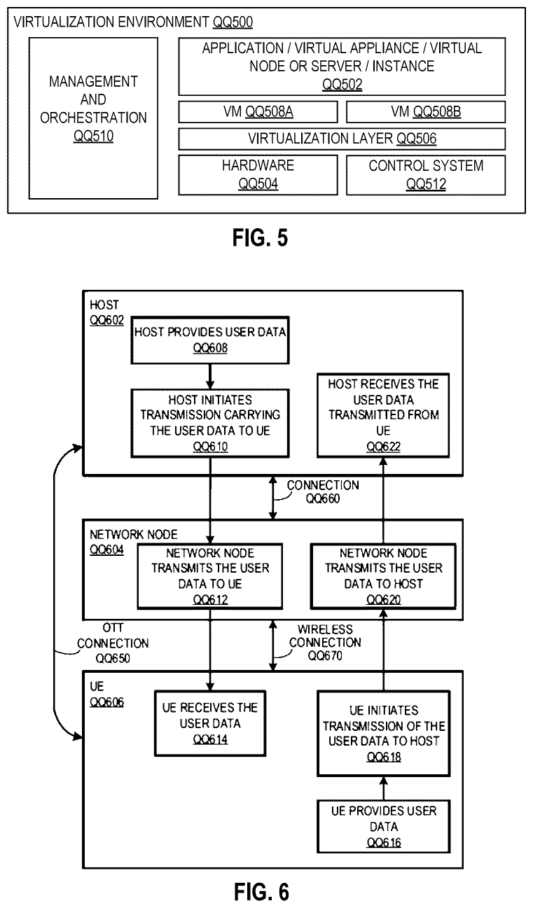

FIG. 3 shows a network node QQ300, which may be an embodiment of the network node 110 of FIG. 5, in accordance with some embodiments.

As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 3 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

FIG. 4 is a block diagram of a host QQ400, which may be an embodiment of the host QQ116 of FIG. 1, in accordance with various aspects described herein.

As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIGURES QQ2 and QQ3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 5 is a block diagram illustrating a virtualization environment QQ500 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

FIG. 6 shows a communication diagram of a host QQ602 communicating via a network node QQ604 with a UE QQ606 over a partially wireless connection in accordance with some embodiments.

Example implementations, in accordance with various embodiments, of the UE (such as a UE QQ112a of FIG. 1 and/or UE QQ200 of FIG. 2), network node (such as network node QQ110a of FIG. 1 and/or network node QQ300 of FIG. 3), and host (such as host QQ116 of FIG. 1 and/or host QQ400 of FIG. 4) discussed in the preceding paragraphs will now be described with reference to FIG. 6.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 1) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

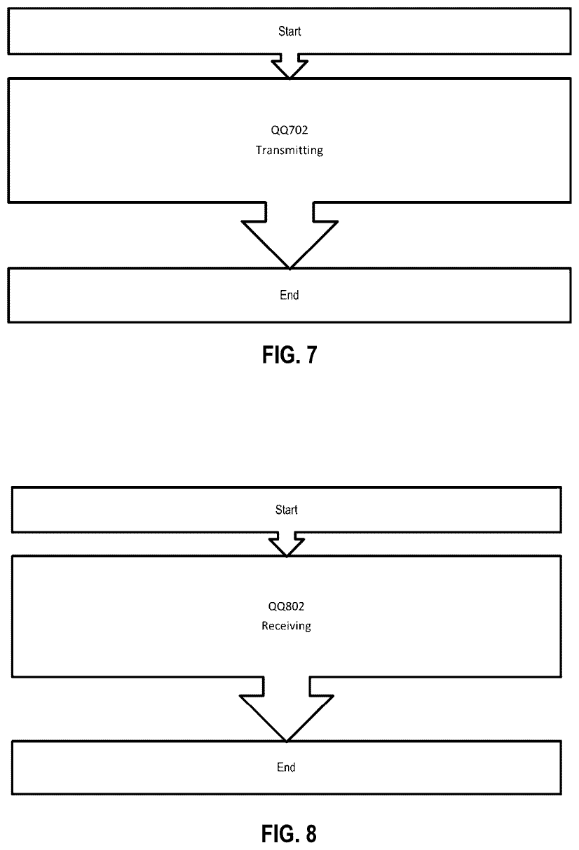

FIG. 7 illustrates an example method by a radio node for measurement reporting for frequency hopping in positioning, according to certain embodiments. In the illustrated embodiment, the method includes a transmitting step at QQ702. For example, at step QQ702, the UE may report, to a first network node, one or more measurement values associated with a measured reference signal. The report is based on measurements of the reference signal over one or more frequency hops across a narrowband or a wideband. At least one of the one or more measurement values is associated with an accumulated bandwidth over one or more frequency hops across the narrowband or the wideband. The measurement values are reported together with an associated bandwidth information, the associated bandwidth information indicating whether the report is based on narrowband or wideband measurements.

In some examples of the method illustrated in FIG. 7, the radio node comprises a UE, the first network node comprises a gNB or an LMF, and the reference signal comprises a DL PRS. In some variants of this example, the method further comprises transmitting, to the first network node, information indicating whether the UE is capable of performing measurements based on wideband and/or narrowband.

In some examples of the method illustrated in FIG. 7, the radio node comprises a second network node (for example a gNB), the first network node comprises an LMF, and the reference signal comprises an UL SRS.

In some examples of the method illustrated in FIG. 7, the narrowband comprises the bandwidth of one frequency hop.

In some examples of the method illustrated in FIG. 7, the wideband comprises the configured bandwidth of the reference signal or the wideband comprises a part of the configured bandwidth of the reference signal and is wider than the bandwidth of one frequency hop.

According to certain embodiments a radio node, for example a UE QQ112, QQ200 or a network node QQ110, QQ300, is provided for measurement reporting for frequency hopping in positioning. The radio node may be configured to, and/or comprising processing circuitry configured to, perform the embodiments relating to the example method illustrated in FIG. 7. FIG. 8 illustrates an example method by a first network node for receiving measurement reporting for frequency hopping in positioning, according to certain embodiments. In the illustrated embodiment, the method includes a receiving step at QQ802. For example, at step QQ802, the network node may receive, from a radio node, a measurement report comprising one or more measurement values associated with a reference signal. The reference signal being transmitted over a plurality of frequency hops, for example by the first network node or another network node. At least one of the one or more measurement values is associated with an accumulated bandwidth over one or more frequency hops across a narrowband or a wideband. The measurement values are reported together with an associated bandwidth information, the associated bandwidth information indicating whether the report is based on narrowband or wideband measurements.

In some examples of the method illustrated in FIG. 8, the radio node comprises a UE, the first network node comprises a gNB or an LMF, and the reference signal comprises a DL PRS. In some variants of this example, the method may further comprise receiving, from the UE, information indicating whether the UE is capable of performing measurements based on wideband and/or narrowband.

In some examples of the method illustrated in FIG. 8, the first network node comprises an LMF, the radio node comprises a second network node (for example a gNB), and the reference signal comprises a UL SRS.

In some examples of the method illustrated in FIG. 8, the narrowband comprises the bandwidth of one frequency hop.

In some examples of the method illustrated in FIG. 8, the wideband comprises the configured bandwidth of the reference signal or the wideband comprises a part of the configured bandwidth of the reference signal and is wider than the bandwidth of one frequency hop.

According to certain embodiments a network node, for example a network node QQ110, QQ300 or another network node (for example QQ108) implementing an LMF, is provided for measurement reporting for frequency hopping in positioning. The network node may be configured to, and/or comprising processing circuitry configured to, perform the embodiments relating to the example method illustrated in FIG. 8.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### NUMBERED EMBODIMENTS

### Group a Example Embodiments

Example Embodiment A1. A method performed by a radio node for measurement reporting for frequency hopping in positioning, the method comprising:
any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising:
providing user data; and
forwarding the user data to a host computer via the transmission to the network node.

### Group B Example Embodiments

Example Embodiment B1. A method performed by a network node for measurement reporting for frequency hopping in positioning, the method comprising:
any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising:
obtaining user data; and
forwarding the user data to a host or a user equipment.

### Group C Example Embodiments

Example Embodiment C1. A method performed by a radio node for measurement reporting for frequency hopping in positioning, the method comprising:
transmitting, to a first network node, a measurement report associated with a reference signal, and
wherein at least one value in the measurement report is associated with accumulated bandwidth information if an accumulated bandwidth is not aligned with a full bandwidth configured for the reference signal, and
wherein the accumulated bandwidth is associated with up to one measurement result.

Example Embodiment C2. The method of Example Embodiment C1, wherein:
the radio node comprises a User Equipment (UE),
the first network node comprises a gNodeB (gNB) or a Location Management Function (LMF), and
the reference signal comprises a downlink (DL) Positioning Reference Signal (PRS).

Example Embodiment C3. The method of Example Embodiment C2, comprising: transmitting, to the first network node, information indicating a capability of the UE to perform wideband PRS frequency hopping measurement reporting and/or narrowband PRS frequency hopping measurement reporting.

Example Embodiment C4. The method of Example Embodiment C3, wherein the information indicating the capability of the UE comprises at least one of:
a first indication as to whether the measurement report can be based on a preferred bandwidth,
a second indication as to whether the measurement report can be based on a narrowband PRS,
a third indication as to whether the measurement report can be based on a full wideband PRS,
a fourth indication as to whether the measurement report can be based on a partial wideband PRS, and/or
a fifth indication as to whether the measurement report can be based on one or more preferred hops.

Example Embodiment C5. The method of Example Embodiment C1, wherein:
the radio node comprises a second network node,
the first network node comprises a Location Management Function (LMF), and
the reference signal comprises a uplink (UL) Sounding Reference Signal (SRS).

Example Embodiment C6. The method of any one of Example Embodiments C1 to C5, comprising determining that the radio node is able to measure all or some frequency hops cross a full wide bandwidth, and wherein the measurement report comprises at least one value associated with the full wide bandwidth.

Example Embodiment C7. The method of any one of Example Embodiments C1 to C5, comprising: if the radio node is not able to measure all or some frequency hops cross a full wide bandwidth, determining that the radio node is able to measure all or some frequency hops cross partial wide bandwidth, and wherein the measurement report comprises at least one value associated with the partial wide bandwidth.

Example Embodiment C8. The method of any one of Example Embodiments C1 to C5, comprising: determining that an accuracy level of at least one measurement based on a narrow bandwidth associated with each hop is higher than an accuracy level of at least one measurement based on a full or partial wide bandwidth, and wherein the measurement report comprises at least one value associated with the narrow bandwidth.

Example Embodiment C9. The method of Example Embodiment C8, wherein the measurement report comprises at least one value associated with the full or partial wide bandwidth.

Example Embodiment C10. The method of any one of Example Embodiments C1 to C9, comprising receiving, from the first network node or another network node, an indication to report at least one of:
at least one value associated with the narrow bandwidth,
at least one value associated with the full wide bandwidth, and/or
at least one value associated with the partial wide bandwidth.

Example Embodiment C11. The method of Example Embodiment C10, wherein the at least one value in the measurement report is included in the measurement report based on the indication.

Example Embodiment C12. The method of any one of Example Embodiments C1 to C11, wherein the measurement report comprises at least one measurement associated with a partial hop. Example Embodiment C13. The method of Example Embodiment C12, wherein the partial hop is determined based on at least one phase offset.

Example Embodiment C14. The method of Example Embodiment C13, comprising receiving the at least one phase offset from the first network node or another network node.

Example Embodiment C11. The method of any one of Example Embodiments C1 to C10, further comprising:
providing user data; and
forwarding the user data to a host via the transmission to the network node.

Example Embodiment C12. The method of any one of Example Embodiments C1 to C10, further comprising:
obtaining user data; and
forwarding the user data to a host or a user equipment.

Example Embodiment C13. A radio node comprising processing circuitry configured to perform any of the methods of Example Embodiments C1 to C12.

Example Embodiment C14. A radio node configured to perform any of the methods of Example Embodiments C1 to C12.

Example Embodiment C15. A radio node comprising processing circuitry configured to perform any of the methods of Example Embodiments C1 to C12.

Example Embodiment C16. A computer program comprising instructions which when executed on a computer perform any of the methods of Example Embodiments C1 to C12.

Example Embodiment C17. A computer program product comprising computer program, the computer program comprising instructions which when executed on a computer perform any of the methods of Example Embodiments C1 to C12.

Example Embodiment C18. A non-transitory computer readable medium storing instructions which when executed by a computer perform any of the methods of Example Embodiments C1 to 12.

### Group D Example Embodiments

Example Embodiment D1. A method performed by a first network node for measurement reporting for frequency hopping in positioning, the method comprising:
receiving, from a radio node, a measurement report associated with a reference signal, and
wherein at least one value in the measurement report is associated with accumulated bandwidth information if an accumulated bandwidth is not aligned with a full bandwidth configured for the reference signal, and
wherein the accumulated bandwidth is associated with up to one measurement result.

Example Embodiment D2. The method of Example Embodiment D1, wherein:
the radio node comprises a User Equipment (UE),
the first network node comprises a gNodeB (gNB) or a Location Management Function (LMF), and
the reference signal comprises a downlink (DL) Positioning Reference Signal (PRS).

Example Embodiment D3. The method of Example Embodiment D2, comprising: receiving, from the UE, information indicating a capability of the UE to perform wideband PRS frequency hopping measurement reporting and/or narrowband PRS frequency hopping measurement reporting.

Example Embodiment D4. The method of Example Embodiment D3, wherein the information indicating the capability of the UE comprises at least one of:
a first indication as to whether the measurement report can be based on a preferred bandwidth,
a second indication as to whether the measurement report can be based on a narrowband PRS,
a third indication as to whether the measurement report can be based on a full wideband PRS,
a fourth indication as to whether the measurement report can be based on a partial wideband PRS, and/or
a fifth indication as to whether the measurement report can be based on one or more preferred hops.

Example Embodiment D5. The method of Example Embodiment D1, wherein:
the first network node comprises a Location Management Function (LMF),
the radio node comprises a second network node, and
the reference signal comprises a uplink (UL) Sounding Reference Signal (SRS).

Example Embodiment D6. The method of any one of Example Embodiments D1 to D5, wherein the radio node is able to measure all or some frequency hops cross a full wide bandwidth, and wherein the measurement report comprises at least one value associated with the full wide bandwidth.

Example Embodiment D7. The method of any one of Example Embodiments D1 to D5, wherein the radio node is not able to measure all or some frequency hops cross a full wide bandwidth, and wherein the radio node is able to measure all or some frequency hops cross partial wide bandwidth, and wherein the measurement report comprises at least one value associated with the partial wide bandwidth.

Example Embodiment D8. The method of any one of Example Embodiments D1 to D5, wherein an accuracy level of at least one measurement based on a narrow bandwidth associated with each hop is higher than an accuracy level of at least one measurement based on a full or partial wide bandwidth, and wherein the measurement report comprises at least one value associated with the narrow bandwidth.

Example Embodiment D9. The method of Example Embodiment D8, wherein the measurement report comprises at least one value associated with the full or partial wide bandwidth.

Example Embodiment D10. The method of any one of Example Embodiments D1 to D9, comprising transmitting, to the radio node, an indication to report at least one of:
at least one value associated with the narrow bandwidth,
at least one value associated with the full wide bandwidth, and/or
at least one value associated with the partial wide bandwidth.

Example Embodiment D11. The method of Example Embodiment D10, wherein the at least one value in the measurement report is included in the measurement report based on the indication.

Example Embodiment D12. The method of any one of Example Embodiments D1 to D11, wherein the measurement report comprises at least one measurement associated with a partial hop. Example Embodiment D13. The method of Example Embodiment D12, wherein the partial hop is determined based on at least one phase offset.

Example Embodiment D14. The method of Example Embodiment D13, comprising transmitting the at least one phase offset to the radio node.

Example Embodiment D15. The method of any one of Example Embodiments D1 to D14, further comprising:
obtaining user data; and
forwarding the user data to a host or a user equipment.

Example Embodiment D16. A network node comprising processing circuitry configured to perform any of the methods of Example Embodiments D1 to D15.

Example Embodiment D17. A network node configured to perform any of the methods of Example Embodiments D1 to D15.

Example Embodiment D18. A computer program comprising instructions which when executed on a computer perform any of the methods of Example Embodiments D1 to D15.

Example Embodiment D19. A computer program product comprising computer program, the computer program comprising instructions which when executed on a computer perform any of the methods of Example Embodiments D1 to D15.

Example Embodiment D20. A non-transitory computer readable medium storing instructions which when executed by a computer perform any of the methods of Example Embodiments D1 to D15.

### Group E Example Embodiments

Example Embodiment E1. A user equipment for measurement reporting for frequency hopping in positioning, the UE comprising:
processing circuitry configured to perform any of the steps of any of the Group A, B, and C Example Embodiments; and
power supply circuitry configured to supply power to the processing circuitry.

Example Embodiment E2. A network node for measurement reporting for frequency hopping in positioning, the network node comprising:
processing circuitry configured to perform any of the steps of any of the Group B and D Example Embodiments;
power supply circuitry configured to supply power to the processing circuitry.

Example Embodiment E3. A user equipment (UE) for frequency hopping in positioning, the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A, B, and C Example Embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

Example Embodiment E4. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A, B, and C Example Embodiments to receive the user data from the host.

Example Embodiment E5. The host of the previous Example Embodiment, wherein the cellular network further includes a network node configured to communicate with the UE to transmit the user data to the UE from the host.

Example Embodiment E 6. The host of the previous 2 Example Embodiments, wherein:
the processing circuitry of the host is configured to execute a host application, thereby providing the user data; and
the host application is configured to interact with a client application executing on the UE, the client application being associated with the host application.

Example Embodiment E7. A method implemented by a host operating in a communication system that further includes a network node and a user equipment (UE), the method comprising: providing user data for the UE; and
initiating a transmission carrying the user data to the UE via a cellular network comprising the network node, wherein the UE performs any of the operations of any of the Group A embodiments to receive the user data from the host.

Example Embodiment E8. The method of the previous Example Embodiment, further comprising:
at the host, executing a host application associated with a client application executing on the UE to receive the user data from the UE.

Example Embodiment E9. The method of the previous Example Embodiment, further comprising:
at the host, transmitting input data to the client application executing on the UE, the input data being provided by executing the host application,
wherein the user data is provided by the client application in response to the input data from the host application.

Example Embodiment E10. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A, B, and C Example Embodiments to transmit the user data to the host.

Example Embodiment E11. The host of the previous Example Embodiment, wherein the cellular network further includes a network node configured to communicate with the UE to transmit the user data from the UE to the host.

Example Embodiment E 12. The host of the previous 2 Example Embodiments, wherein:
the processing circuitry of the host is configured to execute a host application, thereby providing the user data; and
the host application is configured to interact with a client application executing on the UE, the client application being associated with the host application.

Example Embodiment E13. A method implemented by a host configured to operate in a communication system that further includes a network node and a user equipment (UE), the method comprising:
at the host, receiving user data transmitted to the host via the network node by the UE, wherein the UE performs any of the steps of any of the Group A, B, and C Example Embodiments to transmit the user data to the host.

Example Embodiment E14. The method of the previous Example Embodiment, further comprising:
at the host, executing a host application associated with a client application executing on the UE to receive the user data from the UE.

Example Embodiment E15. The method of the previous Example Embodiment, further comprising:
at the host, transmitting input data to the client application executing on the UE, the input data being provided by executing the host application,
wherein the user data is provided by the client application in response to the input data from the host application.

Example Embodiment E16. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of the Group B and D Example Embodiments to transmit the user data from the host to the UE.

Example Embodiment E17. The host of the previous Example Embodiment, wherein:
the processing circuitry of the host is configured to execute a host application that provides the user data; and
the UE comprises processing circuitry configured to execute a client application associated with the host application to receive the transmission of user data from the host.

Example Embodiment E18. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of the Group B and D Example Embodiments to transmit the user data from the host to the UE.

Example Embodiment E19. The method of the previous Example Embodiment, further comprising, at the network node, transmitting the user data provided by the host for the UE.

Example Embodiment E 20. The method of any of the previous 2 Example Embodiments, wherein the user data is provided at the host by executing a host application that interacts with a client application executing on the UE, the client application being associated with the host application.

Example Embodiment E21. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of the Group B and D Example Embodiments to transmit the user data from the host to the UE.

Example Embodiment E22. The communication system of the previous Example Embodiment, further comprising:
the network node; and/or
the user equipment.

Example Embodiment E23. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of the Group B and D Example Embodiments to receive the user data from a user equipment (UE) for the host.

Example Embodiment E 24. The host of the previous 2 Example Embodiments, wherein:
the processing circuitry of the host is configured to execute a host application, thereby providing the user data; and
the host application is configured to interact with a client application executing on the UE, the client application being associated with the host application.

Example Embodiment E 25. The host of the any of the previous 2 Example Embodiments, wherein the initiating receipt of the user data comprises requesting the user data.

Example Embodiment E26. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the steps of any of the Group B and D Example Embodiments to receive the user data from the UE for the host.

Example Embodiment E27. The method of the previous Example Embodiment, further comprising at the network node, transmitting the received user data to the host.

1. A method performed by a radio node (QQ112, QQ200, QQ110, QQ300) for measurement reporting for frequency hopping in positioning, the method comprising:
reporting (QQ702), to a first network node (QQ110, QQ300, QQ108), one or more measurement values associated with a measured reference signal,
wherein the report is based on measurements of the reference signal over one or more frequency hops across a narrowband or a wideband, and
wherein at least one of the one or more measurement values is associated with an accumulated bandwidth over one or more frequency hops across the narrowband or the wideband, and
wherein the measurement values are reported together with an associated bandwidth information, the associated bandwidth information indicating whether the report is based on narrowband or wideband measurements.

2. The method of claim 1, wherein the radio node comprises a User Equipment, the first network node comprises a gNodeB or a Location Management Function, and the reference signal comprises a downlink Positioning Reference Signal.

3. The method of claim 2 further comprising transmitting, to the first network node, information indicating whether the User Equipment is capable of performing measurements based on wideband and/or narrowband.

4. The method of any of claim 1, wherein the radio node comprises a second network node, the first network node comprises a Location Management Function, and the reference signal comprises an uplink Sounding Reference Signal.

5. The method of claim 1, wherein the narrowband comprises the bandwidth of one frequency hop.

6. The method of claim 1, wherein the wideband comprises the configured bandwidth of the reference signal.

7. The method of claim 1, wherein the wideband comprises a part of the configured bandwidth of the reference signal and is wider than the bandwidth of one frequency hop.

8. A method performed by a first network node (QQ110, QQ300, QQ108) for receiving measurement reporting for frequency hopping in positioning, the method comprising:
receiving (QQ802), from a radio node (QQ112, QQ200, QQ110, QQ300), a measurement report comprising one or more measurement values associated with a reference signal, the reference signal being transmitted over a plurality of frequency hops,
wherein at least one of the one or more measurement values is associated with an accumulated bandwidth over one or more frequency hops across a narrowband or a wideband, and
wherein the measurement values are reported together with an associated bandwidth information, the associated bandwidth information indicating whether the report is based on narrowband or wideband measurements.

9. The method of claim 8, wherein the radio node comprises a User Equipment, the first network node comprises a gNodeB or a Location Management Function, and the reference signal comprises a downlink Positioning Reference Signal.

10. The method of claim 9 further comprising receiving, from the User Equipment, information indicating whether the User Equipment is capable of performing measurements based on wideband and/or narrowband.

11. The method of claim 8, wherein the first network node comprises a Location Management Function, the radio node comprises a second network node, and the reference signal comprises a uplink Sounding Reference Signal.

12. The method of claim 8, wherein the narrowband comprises the bandwidth of one frequency hop.

13. The method of claim 8, wherein the wideband comprises the configured bandwidth of the reference signal.

14. The method of claim 8, wherein the wideband comprises a part of the configured bandwidth of the reference signal and is wider than the bandwidth of one frequency hop.

15. A radio node (QQ112, QQ200, QQ110, QQ300) for measurement reporting for frequency hopping in positioning, the radio node configured to:
report, to a first network node (QQ110, QQ300, QQ108), one or more measurement values associated with a measured reference signal,
wherein the report is based on measurements of the reference signal over one or more frequency hops across a narrowband or a wideband, and
wherein at least one of the one or more measurement values is associated with an accumulated bandwidth over one or more frequency hops across the narrowband or the wideband, and
wherein the measurement values are reported together with an associated bandwidth information, the associated bandwidth information indicating whether the report is based on narrowband or wideband measurements.

16. The radio node of claim 15, wherein the radio node comprises a User Equipment, the first network node comprises a gNodeB or a Location Management Function, and the reference signal comprises a downlink Positioning Reference Signal.

17. A network node (QQ110, QQ300, QQ108) for receiving measurement reporting for frequency hopping in positioning, the network node configured to:
receive, from a radio node (QQ112, QQ200, QQ110, QQ300), a measurement report comprising one or more measurement values associated with a reference signal, the reference signal being transmitted over a plurality of frequency hops,
wherein at least one of the one or more measurement values is associated with an accumulated bandwidth over one or more frequency hops across a narrowband or a wideband, and
wherein the measurement values are reported together with an associated bandwidth information, the associated bandwidth information indicating whether the report is based on narrowband or wideband measurements.

18. The network node of claim 17, wherein the radio node comprises a User Equipment, the first network node comprises a gNodeB or a Location Management Function. and the reference signal comprises a downlink Positioning Reference Signal.
